(19) United States
(12) Patent Application Publication
(10) Pub. No.: US 2014/0358746 A1
(43) Pub. Date: Dec. 4, 2014

(54) Method of Implementing a Financial Wellness Programme and a System Therefor

(71) Applicant: Discovery Limited, Sandton (ZA)

(72) Inventors: Darren Segal, Johannesburg (ZA); Robert Hutchinson-Keip, Johannesburg (ZA)

(21) Appl. No.: 14/363,890

(22) PCT Filed: Nov. 28, 2012
(86) PCT No.: PCT/IB12/56783

§ 371 Date: Jun. 9, 2014

(30) Foreign Application Priority Data
Dec. 9, 2011 (ZA) 2011/09079

(51) Int. Cl. G06Q 40/00

(52) U.S. Cl. CPC G06Q 40/12; G06Q 40/025
USPC 705/30

(57) ABSTRACT

A system and method of implementing a financial management programme includes defining a plurality of financial management programme areas and receiving data relating to the financial compliance of an individual or organisation in each of the financial management programme areas. The data is stored in a database and then processing the data to determine an award for the individual or organisation based on their financial compliance.

### BACKGROUND

The present application relates to a method of implementing a financial management programme and a system therefor.

The present invention seeks to motivate users to look after their financial affairs.

### SUMMARY

According to one example embodiment, a method of implementing a financial management programme, the method including:
defining a plurality of financial management programme areas;
receiving data relating to the financial compliance of an individual or organisation in each of the financial management programme areas;
storing the data in a database; and
processing the data to determine an award for the individual or organisation based on their financial compliance.

The method may also include periodically receiving data relating to the financial compliance of the individual or organisation in each of the financial management programme areas and periodically processing the data to determine an award.

In one example embodiment, the reward is a lower interest rate on a loan.

Where the method is applied periodically, the lower interest rate will be varied periodically.

The method may include awarding points to the individual or organisation for their compliance in each of the financial management programme areas wherein the greater the number of points awarded the greater the quantum of the reward.

The at least one financial management programme area includes at least some of saving for retirement, saving for an emergency, having a will, having insurance and having a good credit record.

According to another example embodiment there provided an electronic system for implementing a financial management programme, the system including:
a controller for defining a plurality of financial management programme areas;
a communications module for receiving data relating to the financial compliance of an individual or organisation in each of the financial management programme areas;
a database for storing the data; and
a calculation module for processing the data to determine an award for the individual or organisation based on their financial compliance.

According to another example embodiment, a method of implementing a financial management programme, the method including:
defining a plurality of financial management programme areas;
receiving data relating to the financial compliance of an individual or organisation in each of the financial management programme areas;
storing the data in a database; and
processing the data to determine the pricing of credit for the individual or organisation based on their financial compliance.

According to another example embodiment there provided an electronic system for implementing a financial management programme, the system including:
a controller for defining a plurality of financial management programme areas;
a communications module for receiving data relating to the financial compliance of an individual or organisation in each of the financial management programme areas;
a database for storing the data; and
a calculation module for processing the data to determine the pricing of credit for the individual or organisation based on their financial compliance.

### BRIEF DESCRIPTION OF THE DRAWINGS

FIG. 1 is a block diagram illustrating an example system to implement the methodologies described herein;

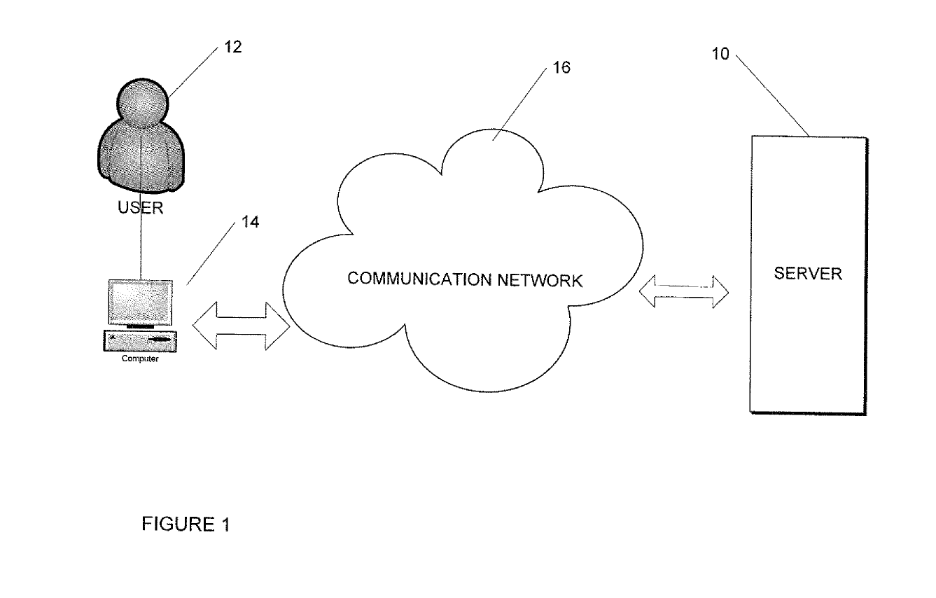

FIG. 2 is a block diagram illustrating the server of FIG. 1 in more detail; and

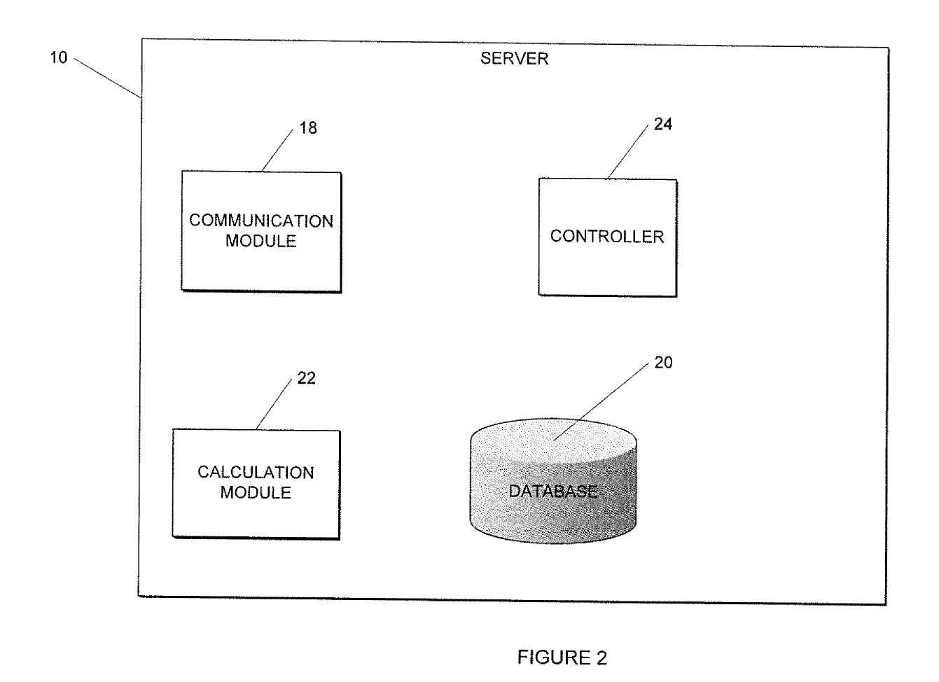

FIG. 3 is a flow chart illustrating the methodology of an example embodiment.

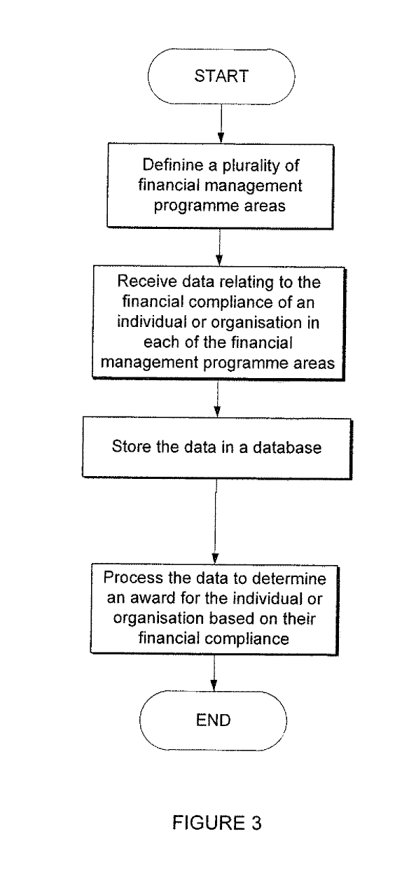

### DESCRIPTION OF EMBODIMENTS

Referring to the accompanying figures, a system and method of implementing a financial management programme is described.

A server 10 includes a number of modules.

The modules described below may be implemented by a machine-readable medium embodying instructions which, when executed by a machine, cause the machine to perform any of the methods described below.

It will be appreciated that embodiments of the present invention are not limited to such architecture, and could equally well find application in a distributed, or peer-to-peer, architecture system. Thus the modules illustrated could be located on one or more servers operated by one or more institutions.

In any event, the method of the present invention is to implement a program designed to educate users on healthy financial behaviours, highlight gaps in their financial positions and management, and to incentivise engagement in a programme to improve their finances. The program will extend across all financial management areas including short and long term insurance and medical aids

The programme will engage customers in the management of their finances, act as a fundamental risk manager for credit risk and will reward them for current sacrifices associated with sound financial behavior ₜhat has a long term beneficial effect on a banking business.

According to one example embodiment, a method of implementing a financial management programme includes defining a plurality of financial management programme areas. In one example these may include at least some of:
1) Saving for retirement
2) Having savings for emergencies
3) Having a will
4) adequacy of the level of insurance cover
5) credit status

The server 10 receives data relating to the financial compliance of an individual or organisation in each of the financial management programme areas defined. For purposes of illustration only, reference will be made to an individual 12 as the user of the system.

Practically this may be implemented by the server 10 conducting a Financial Health Review which comprises of a set of questions designed to gain a good understanding of the user's financial position.

it will be appreciated that the set of questions could be posed to the user in any one of a number of ways.

In one example embodiment, the user is directed to use a device 14 to access the server 10 via a communication network 16.

In one example embodiment, the communication network 16 is the Internet.

The device 14 will communicate with the server 10 via a communication module 18.

The user 12, in this illustrated embodiment, will be presented with a plurality of webpages which they will be required to complete. The webpages will have numerous questions around their financial management including questions directed towards the financial management programme areas listed above.

It will be appreciated that in alternative embodiments, the information could be obtained by an application or software executing on a device 14 which will obtain the user inputs and then package and transmit the data to the communication module 18 of the server 10.

In other embodiments, the communication module 18 may, alternatively or in addition to the above, access one or more systems of financial institutions (not shown) and thus the financial view may be enhanced with automated updating of the value of assets and liabilities.

Information may also be obtained manually and manually updated into the system.

The data collected will be stored in database 20 and will give a snapshot of the user's financial position.

The data will then be processed by a calculation module to determine an award for the individual or organisation based on their financial compliance.

The method may include awarding points to the individual or organisation for their compliance in each of the financial management programme areas wherein the greater the number of points awarded the greater the quantum of the reward. This will be explained in more detail below.

Essentially, there are 3 steps in the programme:
1. Know your finances;
2. Improve your finances; and
3. Get rewarded.

These three steps are achieved by:
1. Complete a financial health review across a broad range of financial behaviours (and ongoing monitoring of finances)
2. Completing activities for improving finances in the categories:
3. Getting rewards for activities and progressing towards a sound financial position.

As described above, the first step comprises of a series of interactive online questionnaires coupled with validated inputs of actual status. Based on the results of these, users will be provided with feedback and advice on best practice when managing their finances.

Users will receive 7500 points on completion of a retirement section which will ask detailed questions on the retirement provisions.

It will be appreciated that the exact number of points mentioned in this document are for illustrative purposes only.

The level of adequacy of provision for retirement (which would be validated through independent verification of the value of retirement assets broker from verified inputs or electronic systemized collection of date) will be calculated. Based on the results of the algorithm users will receive additional points as per the following example table.

| Adequacy | Points per month |
|---|---|
| 0-50% | 0 |
| 50-80% | 1000 |
| 80-100% | 2500 |
| 100-125% | 7500 |
| 125%+ | 10 000 |

Users will receive 2500 points on completion of the savings section and additional points based on their absolute level of savings as per the example table:

| Month's salary (change to | |
|---|---|
| expenses or make flat) | Max points p.a. |
| 1 month | 500 |
| 2 months | 1500 |
| 3 months+ | 2500 |

Points for level of savings will be based on validated data of balances in an individual's savings account

Savings would be money that is readily available in cash or accessible from an “access” mortgage.

Users will receive 5000 points for completing a section which will ask questions on whether they have a will (2 500 points) and whether they have checked it is still valid each year (2 500 points).

Users will receive 7500 points for completing a section which will evaluate the types of insurance cover that the client has. This section will deal with life cover, disability cover, medical aid and short term insurance.

Part of completing this section will ask for permission to access all their insurance policy information through Astute (an industry system that pulls insurance policy details from all insurance companies).

If a user has the following insurance points will be awarded as per the following example table:

| | |
|---|---|
| Medical Aid | 2500 |
| Life insurance | 2500 |
| Disability Cover | 2500 |
| Vehicle cover | 1000 |
| Content | 1000 |
| Building | 500 |

Users will receive 2500 points for completing a section involving the option to buy a full credit report.

If their credit card account is in good standing then additional 6000 points will be awarded. In one example, 500 points will be allocated monthly.

### SUMMARY OF POINTS

| | | Maximum |
|---|---|---|
| Category | Activity | Points p.a |
| Know your Position | Financial Health Review | 5000 |
| Retirement | Completed retirement adequacy | 7500 |
| | questionnaire | |
| adequacy | 0-50% | 0 |
| | 50-80% | 1000 |
| | 80-100% | 2500 |
| | 100-125% | 7500 |
| | 125%+ | 10 000 |
| Savings | Savings | 2500 |
| Months savings | 1 month | 500 |
| | 2 months | 1500 |
| | 3 months+ | 2500 |
| Insurance | Insurance | 7500 |
| | Medical Aid | 2500 |
| | Life insurance | 2500 |
| | Disability Cover | 2500 |
| | Vehicle cover | 1000 |
| | Content | 1000 |
| | Building | 500 |
| Credit record | Credit record | 2500 |
| | Credit Card in good standing | 6000 |

Total points available 53 500

In one example embodiment, points will count towards a status. Users will receive rewards based on their status at any given point in time (there will be no carry over points). Points for activities will be valid for a period of time, for example until 31 December each year.

| Status | Annual Threshold |
|---|---|
| * | 0 |
| ** | 15 000 |
| *** | 35 000 |
| **** | 45 000 |

Rewards are used as an incentive to change behavior. In one example embodiment, various rewards are envisaged, some associated with banking products and other more “retail” benefits.

For example, the amount of points or status level can be used to grant rebates on interest rates on lending products. For example if a home loan is granted at the bank base interest rate (9%) each status can be used to grant a discount to the bank base rate. E.g.:
* bank base rate =9%
** bank base rate −0.25%=8.75%
*** bank base rate −0.5%=8.5%
**** bank base rate −1% =8.0%

One advantage in this is that standard practice is for banks to determine the interest rate at time of application, assuming that the credit risk profile remains the same throughout the term of the loan. An unrealistic assumption on long term loans such as a 20 year home loan. This reward allows for dynamic pricing of loans through the life cycle of the loan, with the pricing adapting to the changing economic and risk circumstances of the client. Either effectively increasing the interest rate as risks profile increases or reducing the rate as risk profile decreased.

In this example embodiment, the programme is used to implement a dynamic pricing of credit whereby the individual or organisation are continually monitored and based on their engagement with the financial wellness programme the pricing on their credit is altered either higher or lower.

Another example award could be a banking reward.

The reward can be passed back to customers in the form of banking-related benefits. Some examples are:
Discounts on transaction fees
Bonus interest rates on savings products
Discounted fees on investment products
Discounted fees for advice

In addition, rewards can be paid in the form of non-banking benefits. These would be hedonistic rewards or discounts on grudge purchases. Examples include:
Discount on data
Discounts at coffees shops
Discounts on entertainment
Discounts on DSTV contracts
Discounts on computers and phones
Discounts on purchases at retail partner stores
Discounts on travel (airline and car hire)
Discount on experiences
Boosting salaries

It will be appreciated that the method may also be applied periodically.

This would include periodically receiving data relating to the financial compliance of the individual or organisation in each of the financial management programme areas and periodically processing the data to determine an award as has been described above.

Thus it will be appreciated that the core of the system would be to record the financial wellness activities of the customer.

The system determines the correlation between the financial wellness programme and credit risk. It would also look at the correlation between the wellness programme and profitability of a banking customer. (It is assumed that the rewards programme may result in better retention of customers, broader product penetration, greater usage of products, etc).

1. A method of implementing a financial management programme, the method including:
defining, with a computer, a plurality of financial management programme areas;
receiving, with a computer, data relating to the financial compliance of an individual or organisation in each of the financial management programme areas;
storing, with a computer, the data in a database; and
processing, with a computer, the data to determine an award for the individual or organisation based on their financial compliance,

2. A method according to claim 1 further including periodically receiving data, with a computer, relating to the financial compliance of the individual or organisation in each of the financial management programme areas and periodically processing, with a computer, the data to determine an award.

3. A method according to claim 1 wherein the reward is a lower interest rate on a loan.

4. A method according to claim 3 wherein where the method is applied periodically, the lower interest rate will be varied periodically.

5. A method according to claim 1 wherein the method includes awarding points, with a computer, to the individual or organisation for their compliance in each of the financial management programme areas wherein the greater the number of points awarded the greater the quantum of the reward.

6. A method according to claim 1 wherein the at least one financial management programme area includes at least some of saving for retirement, saving for an emergency, having a will, having insurance and having a good credit record.

7. An electronic system for implementing a financial management programme, the system including:
a controller for defining a plurality of financial management programme areas;
a communications module for receiving data relating to the financial compliance of an individual or organisation in each of the financial management programme areas;
a database for storing the data; and
a calculation module for processing the data to determine an award for the individual or organisation based on their financial compliance.

8. A system according to claim 7 wherein the communications module further includes periodically receiving data relating to the financial compliance of the individual or organisation in each of the financial management programme areas and the calculation module periodically processes the data to determine an award.

9. A system according to claim 8 wherein the reward is a lower interest rate on a loan.

10. A system according to claim 9 wherein where the calculation is periodically calculated, the lower interest rate will be varied periodically.

11. A system according to claim 8 wherein the calculation module awards points to the individual or organisation for their compliance in each of the financial management programme areas wherein the greater the number of points awarded the greater the quantum of the reward.

12. A system according to claim 8 wherein the at least one financial management programme area includes at least some of saving for retirement, saving for an emergency, having a will, having insurance and having a good credit record.

13. A method of implementing a financial management programme, the method including:
defining, with a computer, a plurality of financial management programme areas;
receiving, with a computer, data relating to the financial compliance of an individual or organisation in each of the financial management programme areas;
storing, with a computer, the data in a database; and
processing, with a computer, the data to determine the pricing of credit for the individual or organisation based on their financial compliance.

14. An electronic system for implementing a financial management programme, the system including:
a controller for defining a plurality of financial management programme areas;
a communications module for receiving data relating to the financial compliance of an individual or organisation in each of the financial management programme areas;
a database for storing the data; and
a calculation module for processing the data to determine the pricing of credit for the individual or organisation based on their financial compliance.
